(19) United States
(12) Patent Application Publication
(10) Pub. No.: US 2021/0382486 A1
(43) Pub. Date: Dec. 9, 2021

(54) WORK AREA MONITORING SYSTEM AND METHOD OF OPERATING A WORK VEHICLE AT A WORK AREA

(71) Applicant: DEERE & COMPANY, Moline, IL (US)

(72) Inventors: AMY K. JONES, ASBURY, IA (US); KEITH J. LENSING, ASBURY, IA (US); KEITH N. CHASTON, DUBUQUE, IA (US); MICHAEL G. KEAN, MAQUOKETA, IA (US); BRETT S. GRAHAM, DUBUQUE, IA (US)

(21) Appl. No.: 16/892,257

(22) Filed: Jun. 3, 2020

(51) Int. Cl. G05D 1/02; B60Q 1/24

(52) U.S. Cl. CPC G05D 1/0212; G05D 1/0231; B60Q 1/24

(57) ABSTRACT

A method of operating a work vehicle at a work area and a work area monitoring system for a work vehicle are provided. The method includes monitoring a target area in the work area and activating a response on the work vehicle directed toward the target area upon satisfaction of a work area condition in the work area.

### BACKGROUND

Work vehicles operate in work areas to accomplish such tasks as earth moving, agricultural tasks, hauling, and other tasks with occasional or frequent movement of the work vehicle to new locations in or outside of the work area. The work vehicle may have one or more work tool that is operated in the work area to accomplish tasks. Multiple work vehicles, other equipment, personnel, and/or mobile and/or fixed objects may operate and/or be positioned together in the work area. Personnel and operators of work vehicles and other equipment maintain awareness of the work vehicles, equipment, and other personnel and objects within the work area. In a non-limiting example, an operator of a construction work vehicle may be positioned in the operator station of the work vehicle and visually check the surroundings of the work vehicle before or while controlling movement or another operation of the work vehicle and/or operating a work tool of the work vehicle to accomplish one or more tasks in the work area.

### SUMMARY

Various aspects of examples of the present disclosure are set out in the claims.

In an embodiment of the present disclosure, a method of operating a work vehicle at a work area is provided. The method includes monitoring a target area in the work area and activating a response on the work vehicle directed toward the target area upon satisfaction of a work area condition in the work area.

In an embodiment of the present disclosure, a work area monitoring system for a work vehicle is provided. The system includes an input module mounted to the work vehicle and configured to monitor a target area in a work area and an output module in communication with the input module and configured to activate a response on the work vehicle directed toward the target area upon satisfaction of a work area condition in the work area.

The above and other features will become apparent from the following description and accompanying drawings.

### BRIEF DESCRIPTION OF THE DRAWINGS

The detailed description of the drawings refers to the accompanying figures in which:

FIG. 1 illustrates a top schematic view of a work area monitoring system for a work vehicle in accordance with an embodiment of the present disclosure;

FIG. 2 illustrates a side schematic view of a work area monitoring system for a work vehicle in accordance with an embodiment of the present disclosure; and

FIG. 3 illustrates a method of operating a work vehicle at a work area in accordance with an embodiment of the present disclosure.

Like reference numerals are used to indicate like elements throughout the several figures.

### DETAILED DESCRIPTION

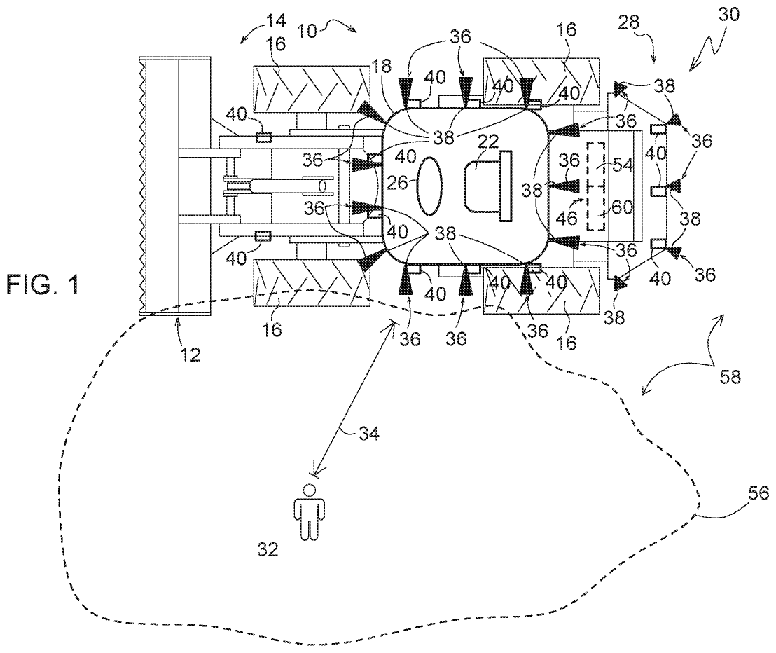

At least one embodiment of the subject matter of this disclosure is understood by referring to FIGS. 1 through 3 of the drawings.

Referring now to FIG. 1, a work vehicle 10 is illustrated in accordance with an embodiment of the present disclosure. The work vehicle 10 of the illustrated embodiment is a front loader construction vehicle, but the work vehicle 10 in additional embodiments includes any other vehicle configured for use in the construction industry, agricultural industry, or forestry industry or any other vehicle configured for on or off-road use. The work vehicle 10 of the illustrated embodiment includes a work tool 12. Although the work vehicle 10 of FIG. 1 illustrates a bucket as the work tool 12, the work tool 12 of one or more embodiments includes any one or more construction, agricultural, or other attachments, implements, or work tools couple to or configured to operate at a front end 14 of the work vehicle 10, a rear end 28 of the work vehicle 10, or at any other location relative to the work vehicle 10. The work vehicle 10 of the illustrated embodiment includes four wheels 16 configured to move the work vehicle 10 relative to a ground surface, but any number or combination of wheels, tracks, and/or other ground-engaging members may be included in additional embodiments of the present disclosure. The work vehicle 10 of the illustrated embodiment further includes an operator station 18 configured to contain, locate, or otherwise position an operator (not shown) to enable the operator to operate the work vehicle 10. The operator 20 of the illustrated embodiment controls the work vehicle 10, the work tool 12, and/or any other aspect of the work vehicle 10 from an operator position 22 in or at the operator station 18 using one or more work vehicle control(s) 26 including, without limitation, a steering wheel, a joystick, and/or another interface or engagement device.

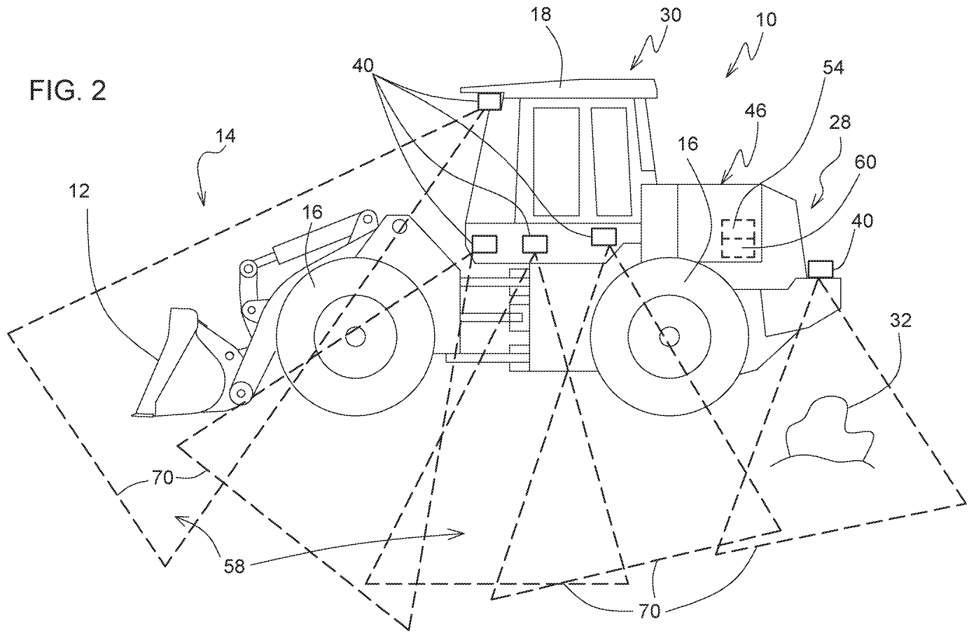

Referring now to FIG. 2 with continuing reference to FIG. 1, a work area monitoring system 30 is included in one or more embodiments of the present disclosure. The system 30 illustrated in FIG. 1 includes an input module 54 mounted to the work vehicle 10 and configured to monitor a target area 56 in the work area 58. The system 30 of the embodiments illustrated includes one or more sensors 36 positioned or configured to be positioned at sensor position(s) on, around, or at the work vehicle 10 as shown in FIGS. 1 and 2. The sensors 36 sense or are configured to sense one or more object(s) 32. The object(s) 32 of one or more embodiments includes any one or multiple stationary or moving or movable objects, individual(s), such as shown in FIG. 1, obstacle(s), such as shown in FIG. 2, boundary, and/or other physical anomaly to the area surrounding the work vehicle 10. In a non-limiting example, the object 32 includes another vehicle (not shown) approaching the work vehicle 10 that the work vehicle 10 and/or the system 30 may sense and indicate to the operator in order for the operator to control the work vehicle 10 away from the object 32 and/or take another action. In additional embodiments not illustrated, there are multiple objects 32 located at different locations relative to the work vehicle 10 that the work vehicle 10 and/or the system 30 simultaneously and/or separately senses and indicates to the operator 20. As described in the embodiments herein, the term “object” included in any embodiment refers to any one or multiple objects sensed by the work vehicle 10 or the system 30.

The sensors 36 of the illustrated embodiments include ultrasonic sensors, but the sensors 36 include one or more infrared, laser or radar based, or any other object-sensing devices or systems in additional embodiments of the present disclosure. The sensor positions 38 for the sensors 36 of the illustrated embodiment are located on or at the operator station 18 and/or the rear end 28 as illustrated in FIG. 1, but the sensor positions 38 of other embodiments may be located elsewhere, including on or at the front end 14, the work tool 12, and/or any other portion of the work vehicle 10. The sensors 36 are oriented away from the operator station 18, the operator 20, and/or the work vehicle 10 and are configured to sense the object(s) 32.

The work vehicle 10 and/or the system 30 of one or more embodiments includes a controller 46. The controller 46 receives or is configured to receive one or more sensor signals from the sensors 36 in an embodiment. In an embodiment, the sensor signal includes a signal distance value representing the distance 34 between the sensor 36 and the object 32. Accordingly, in at least one embodiment, the controller 46 receives or otherwise determines a signal location value, which is based on the sensor position 38 of the signal-sending sensor 36, and the signal distance value, which is based on the distance 34 between the sensor 36 and the object 32 sensed by the signal-sending sensor 36.

The system 30 illustrated in FIGS. 1 and 2 further includes an output module 60 in communication with the input module 54. The input module 54 is in communication with one or more sensors, signal sources, and/or modules as will be described further below with regard to specific embodiments. The output module 60 activates or is configured to activate a response on the work vehicle 10 directed toward the target area 56 upon satisfaction of a work area condition in the work area 58.

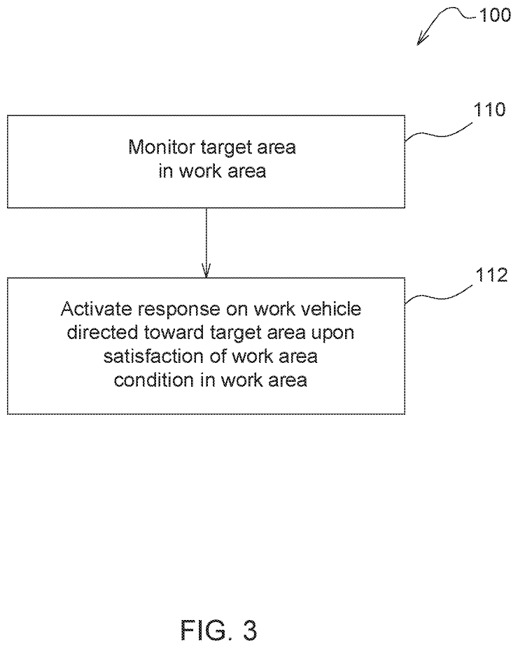

Referring to FIG. 3, in embodiments of the present disclosure, a method 100 of operating the work vehicle 10 at the work area 58 includes monitoring, at step 110, the target area 56 in the work area 58 and activating, at step 112, a response on the work vehicle 10 directed toward the target area 56 upon satisfaction of a work area condition in the work area 58.

The response on or of the work vehicle 10 described herein of various embodiments of the vehicle 10, the system 30, and/or the method 100 of the present disclosure includes activation or illumination of lighting, including without limitation lighting sufficient to illuminate the target area 56 and/or the work area 58, capturing a photographic, thermal, or other image or images of the target area 56 and/or the work area 58, initiating a video and/or audio recording of the target area 56 and/or the work area 58, and/or scanning or otherwise receiving input of the target area 56 and/or the work area 58.

Satisfaction of the work area condition in the work area 58 described herein of various embodiments of the vehicle 10, the system 30, and/or the method 100 may include, without limitation, one or more of the sensor(s) 36 sensing the object(s) 32 in or at the target area 56 and/or the work area 58, the work vehicle 10 being relocated in, moving across, or moving at the work area 58, and/or a lapsing of a predetermined period of time.

In one or more embodiments, the work vehicle 10 is in an unoccupied state at the work area 58. An unoccupied state includes the work vehicle 10 not having the operator 20 located at or in the operator station 18 in an embodiment. In another embodiment, an unoccupied state of the work vehicle 10 includes the work vehicle 10 being in a non-operational state. In an embodiment, such as during an unoccupied state of the work vehicle 10 at the work area 58, the input module 54 monitors or is further configured to monitor the target area 56 in the work area 58 with one or more of the sensor(s) 36. The output module 60 activates or is configured to activate the response on the work vehicle 10 directed toward the target area 56 upon sensing the presence or location of the object(s) 32 at the target area 56 with the one or more sensor(s) 36.

As stated previously, the output module 60 activates the response on the work vehicle 10 directed toward the target area 56 upon satisfaction of the work area condition in the work area 58. The output module 60 of an embodiment for an unoccupied state of the work vehicle 10 activates the response upon one or more of the sensor(s) 36 sensing the object(s) 32 in or at the target area 56 and/or the work area 58 as satisfaction(s) of the work area condition. As shown in FIGS. 1 and 2, the system 30 of certain illustrated embodiments further includes a plurality of lamps 40 or other illuminating members positioned at a plurality of lamp positions. In the illustrated embodiments, the lamp positions directionally correspond to the sensor positions 38. As will be appreciated from the additional description below, in some embodiments, the activation or intensity of one or more of the lamp(s) 40 depends upon and/or corresponds to the sensor(s) 36 sensing the object(s) 32 as a satisfaction of the work area condition. In additional embodiments described below, the lamps 40 are replaced by or supplemented with a camera, scanner, or other device, the actuation or initiation of which may depend upon and/or correspond with the position of the sensor(s) 36 sensing the object(s) 32 in particular embodiments.

The response on or of the work vehicle 10 in the system 30 and/or the method 100 includes activation or illumination of the lamps 40 or other lighting, including without limitation lighting sufficient to illuminate the target area 56 and/or the work area 58. The target area 56 may be one portion of the area surrounding the work vehicle 10, as shown in FIG. 1, or the target area 56 may include multiple portions of the surrounding area or the entire area around the work vehicle 10. One or multiple lamps 40 or other lighting may be utilized, simultaneously or separately, to provide a light beam 70 or otherwise illuminate one or more target area(s) 56 of the work area 58. Accordingly, the system 30 and/or the vehicle 10 illuminate or otherwise make visible one or more object(s) 32 that are near or moving toward the work vehicle 10 and/or improve the navigation and/or inspection of the target area 56 and/or the work area 58 by an individual, such as an operator, near or moving toward the work vehicle 10.

In one or more embodiments, the work vehicle 10 is in an operational state at the work area 58. An operational state includes, in particular non-limiting embodiments, the work vehicle 10 being occupied by the operator 20 at or in the operator station 18, being in the process of performing an operation of the work vehicle 10, and/or traveling in, at, or across the work area 58.

In one or more embodiments when the work vehicle 10 is in an operational state at the work area 58, the input module 54 determines or is configured to determine a location of the work vehicle 10 in the work area 58 relative to the target area 56. The input module 54 determines the location of the work vehicle 10 by receiving input or determining input through a global position system (GPS), inertial measurement, and/or any other location-determining system or process. In such embodiments, satisfaction of the work area condition in the work area 58 includes the work vehicle 10 being relocated or moving in the work area 58.

In one or more embodiments, such as when the work vehicle 10 is in an operational state at the work area 58, satisfaction of the work area condition in the work area 58 includes the input module 54 determining an existence of an anomaly in the work area. The anomaly includes, without limitation, a barrier, object, terrain deviation, and/or other element or elements that is/are inconsistent with the remaining work area 58, a historical set of input values to the system 30 and/or the vehicle 10 and/or a stored algorithm or reference data used to determine or define the existence of an anomaly. In one non-limiting example, a construction work vehicle traveling across and scanning or otherwise sensing the work area 58 may approach a large rock obstacle as an anomaly to satisfy the work area condition.

In an embodiment, when the work vehicle 10 is in an operational state or an unoccupied state, the output module 60 is further configured, directly or indirectly, to capture one or more image(s) of the target area 56 upon the input module 54 determining the existence of an anomaly in the work area 58. The output module 60 may include or be in communication with a still image or video camera, thermal imaging camera, and/or other imaging device to capture the one or more images of the work area 58. The output module 60 and/or another device of the system 30 and/or the vehicle 10 may store, onboard or remotely, and/or transmit the image(s) for processing, analysis, and/or future reference.

In an embodiment, the output module 60 is further configured to scan the target area 56 upon the input module 54 determining the existence of an anomaly in the work area. The output module 60 may include or be in communication with a three-dimensional scanner, radar or laser-based range finder, and/or another scanning device to scan the target area 56. In the above non-limiting example, upon the determining the existence of the anomaly, the system 30 and/or the vehicle 10 may capture the image of the obstacle or scan the area of or around the obstacle in order to, in some examples, communicate or record the location and/or physical details of the obstacle for planning and operation in the work area 58.

In an embodiment of the present disclosure, the satisfaction of the work area condition in the work area 58 includes a lapsing of a predetermined period of time. In a non-limiting example, the system 30 and/or the vehicle 10 predetermines a five-minute period of time such that, in the non-limiting example, the work area condition is satisfied repeatedly every five minutes. In the non-limiting example, the input module 54 communicates with the output module 60 to activate a response on the work vehicle 10 directed toward the target area 56, such as actuation or initiation of image capturing, as described herein, upon satisfaction of the work area condition of the lapsing of the predetermined time period. Accordingly, the system 10 and/or the vehicle 10 may capture images of the work area 58 as the work vehicle 10 operates in the work area 58 in order to store, onboard or remotely, and/or transmit the images for processing, analysis, and/or future reference.

The steps, functions, and methods of each embodiment of the work vehicle 10 and/or the system 30 described herein form part of one or more embodiments of the method 100 of operating the work vehicle 10 at the work area 58 illustrated in FIG. 3 and described herein.

Without in any way limiting the scope, interpretation, or application of the claims appearing below, it will be appreciated that the work vehicle 10, the system 30, and the method 100 of the embodiments of the present disclosure improve the security of the work vehicle 10 and the work area 58. In a non-limiting example, the system 30, the vehicle 10, and/or the method 100 illuminates the work area 58 and/or capture an image or video recording upon the determination that an individual is approaching the work vehicle 10, such as when the work vehicle 10 is unoccupied. Further, the work vehicle 10, the system 30, and/or the method 100 improve the safety and comfort of an operator of the work vehicle 10 by illuminating the work area 58 near the work vehicle 10 when the operator is approaching the work area 58. Furthermore, the work vehicle 10, the system 30, and/or the method 100 improve operation of the work vehicle 10 in the work area 58 via, in particular non-limiting examples, scanning, capturing image(s), or video recording the work area 58 to monitor the work area 58 and/or the status of operations in the work area 58.

As used herein, “e.g.” is utilized to non-exhaustively list examples and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

What is claimed is:

1. A method of operating a work vehicle at a work area, the method comprising:
monitoring a target area in the work area; and
activating a response on the work vehicle directed toward the target area upon satisfaction of a work area condition in the work area.

2. The method of claim 1, wherein the work vehicle is in an unoccupied state at the work area, wherein monitoring the target area in the work area comprises monitoring with at least one sensor, and wherein satisfaction of the work area condition in the work area comprises sensing a presence of an object at the target area with the at least one sensor.

3. The method of claim 2, wherein activating the response on the work vehicle comprises activating lighting directed toward the target area upon sensing the presence of the object at the target area with the at least one sensor.

4. The method of claim 2, wherein activating the response on the work vehicle comprises capturing an image of the target area upon sensing the presence of the object at the target area with the at least one sensor.

5. The method of claim 2, wherein activating the response on the work vehicle comprises initiating a video recording of the target area upon sensing the presence of the object at the target area with the at least one sensor.

6. The method of claim 1, wherein the work vehicle is in an operational state at the work area, wherein monitoring the target area in the work area comprises determining a vehicle location in the work area relative to the target area, and wherein satisfaction of the work area condition in the work area comprises the work vehicle relocating in the work area.

7. The method of claim 6, wherein activating the response on the work vehicle comprises activating lighting directed toward the target area upon the work vehicle relocating in the work area.

8. The method of claim 6, wherein activating the response on the work vehicle comprises capturing at least one image of the target area upon the work vehicle relocating in the work area.

9. The method of claim 6, wherein activating the response on the work vehicle comprises initiating a video recording of the target area upon the work vehicle relocating in the work area.

10. The method of claim 1, wherein the work vehicle is in an operational state in the work area, and wherein satisfaction of the work area condition in the work area comprises a lapsing of a predetermined period of time.

11. The method of claim 1, wherein satisfaction of the work area condition in the work area comprises determining an existence of an anomaly in the work area.

12. A work area monitoring system for a work vehicle, the system comprising:
an input module mounted to the work vehicle and configured to monitor a target area in a work area; and
an output module in communication with the input module and configured to activate a response on the work vehicle directed toward the target area upon satisfaction of a work area condition in the work area.

13. The system of claim 12, wherein the work vehicle is in an unoccupied state at the work area, wherein the input module is further configured to monitor the target area in the work area with at least one sensor, and wherein the output module is further configured to activate the response on the work vehicle directed toward the target area upon sensing a presence of an object at the target area with the at least one sensor.

14. The system of claim 12, wherein the input module is further configured to determine a vehicle location in the work area relative to the target area when the work vehicle is in an operational state at the work area, and wherein satisfaction of the work area condition in the work area comprises the work vehicle being relocated in the work area.

15. The system of claim 12, wherein the work vehicle is in an operational state in the work area, and wherein satisfaction of the work area condition in the work area comprises a lapsing of a predetermined period of time.

16. The system of claim 12, wherein satisfaction of the work area condition in the work area comprises the input module determining an existence of an anomaly in the work area.

17. The system of claim 16, wherein the output module is further configured to capture at least one image of the target area upon the input module determining the existence of an anomaly in the work area.

18. The system of claim 16, wherein the output module is further configured to scan the target area upon the input module determining the existence of an anomaly in the work area.
